(19) United States
(12) Patent Application Publication
(10) Pub. No.: US 2025/0132717 A1
(43) Pub. Date: Apr. 24, 2025

(54) DYNAMIC MULTI AXIS MOUNTING PLATFORM SYSTEM

(71) Applicant: Michael Evert Bunner, Lake George, CO (US)

(72) Inventor: Michael Evert Bunner, Lake George, CO (US)

(21) Appl. No.: 18/985,247

(22) Filed: Dec. 18, 2024

Related U.S. Application Data
(60) Provisional application No. 63/544,916, filed on Oct. 19, 2023.

(51) Int. Cl. H02S 20/32; H02S 10/40

(52) U.S. Cl. CPC H02S 20/32; H02S 10/40

(57) ABSTRACT

A Dynamic Multi Axis Mounting Platform System includes at least one mounting platform with receiver hitch couplers and extension arms secured by receiver hitch pins and safety clips. The system incorporates multiple receiver hitch coupler types and extension arms including outriggers, legs, and columns that enable secure mounting in various orientations. An optional vertical/horizontal clevis swing plate assembly may be used if necessary in some configurations and provides 180-degree rotation capabilities in both planes, while swing jacks enable leveling and height adjustment. The system's modular design accommodates diverse applications including solar panel mounting, structural support, marine installations, and trailer bed configurations. Manufactured using various materials with specialized surface treatments, the system maintains structural integrity across different environments. The spider-like configuration allows sliding adjustment along receiver hitch tubes, while standardized connection requirements ensure secure assembly. Applications range from commercial solar farms to submersible equipment mounting, with expandability in all directions through standardized receiver hitch connections.

### CROSS-REFERENCE TO RELATED APPLICATIONS

This application claims the benefit of priority to U.S. Provisional Patent Application 63/544,916 filed on Oct. 19, 2023, which is hereby incorporated by reference in its entirety as a non-limiting example of a Dynamic Multi Axis Equipment Mounting Platform.

### BACKGROUND OF THE INVENTION

Mounting equipment, appliances, and fixtures presents numerous challenges across residential, commercial, and mobile applications. Traditional mounting solutions often require complex and time-consuming installations that demand permanent modifications to structures or vehicles, while failing to provide optimal stability and positioning flexibility.

Current solar panel mounting systems lack efficient adjustment capabilities for sun tracking, limiting energy capture potential. Existing solutions don't readily accommodate manual or automated adjustment mechanisms, requiring complex permanent installations that reduce overall system efficiency.

Marine and underwater installations face particular difficulties, as conventional mounting systems aren't designed for underwater assembly or adjustment while maintaining structural integrity. Similarly, structural support systems for buildings and communication towers typically require permanent installation with limited adjustment capabilities, failing to provide flexibility for varying load distributions.

Commercial solar farm installations are constrained by mounting systems that lack expandability and reconfigurability for large-scale deployments. These systems often can't effectively accommodate auxiliary equipment alongside solar panels while maintaining stability. Vehicle and trailer mounting solutions typically require permanent modifications and separate trailer registration and maintenance, limiting mobility and increasing operational costs.

Traditional mounting systems also struggle with multi-directional expansion and positioning adjustment after initial installation. They lack the ability to extend mounting surfaces in multiple directions while maintaining structural integrity, particularly in challenging environments such as rough terrain or off-grid locations. Current solutions often lack adequate weather resistance or adaptability across diverse installation scenarios.

Conventional methods of attaching equipment, appliance furnishings, fixtures or any combination thereof inside or outside of structures or vehicles often involve several challenges, including the need for complex and time-consuming installations that often require permanent modifications to the structure or the vehicle. Additionally, these fixed installations may not always provide the optimal level of stabilized staging for the site, the vehicle, or the trailer to mount equipment, appliances, furnishings, fixtures or any combination thereof.

### SUMMARY OF THE INVENTION

A Dynamic Multi Axis Mounting Platform System is disclosed that provides versatile mounting solutions across diverse applications. The system comprises at least one mounting platform with receiver hitch couplers and extension arms, enabling secure attachment and multi-directional expansion capabilities.

The system's core innovation lies in its modular design, incorporating multiple types of receiver hitch couplers including T-couplers, flat plate couplers, baseplate/wall mount couplers, plus (+) couplers, double end strait coupler, and outside corner coupler. These components work in conjunction with receiver hitch tube outriggers, legs, and columns to create adaptable mounting configurations secured by receiver hitch pins and safety clips.

A key feature is the vertical/horizontal clevis swing plate assembly that enables 180-degree rotation in both horizontal and vertical planes. The system's adaptability is further enhanced through swing jacks or hydraulic rams for leveling and height adjustment, while maintaining structural integrity through standardized connection requirements.

The invention's versatility in various embodiments extends to various applications, including solar panel mounting with manual or electro-mechanical tracking capabilities, structural support for buildings and towers, and marine installations. The system can be configured in a spider-like arrangement, allowing sliding adjustment along receiver hitch tubes and virtually unlimited expansion through interconnected platforms.

Manufacturing flexibility is achieved through the use of various materials including metals, especially aluminum, and glass, graphite, graphene, composites, and alternative materials, with multiple surface treatment options ensuring durability across different environments. The system's modular nature enables customization for specific applications while maintaining standardized connection methods throughout all configurations.

The invention in various embodiments addresses challenges in both permanent and temporary mounting scenarios, providing solutions for off-grid installations, RV applications, and commercial deployments. Its ability to expand exponentially in all directions while maintaining stability through secure interconnections makes it particularly suitable for large-scale installations such as commercial solar farms, wind turbines and manufacturing applications.

### BRIEF DESCRIPTION OF THE DRAWINGS

FIG. 1 depicts an isometric view of the Dynamic Multi Axis Mounting Platform System in an embodiment.

FIG. 2 depicts a lateral back view of the example Dynamic Multi Axis Mounting Platform System corresponding to FIG. 1 in an embodiment.

FIG. 3 depicts a lateral front view of the example Dynamic Multi Axis Mounting Platform System corresponding to FIG. 1 in an embodiment.

FIG. 4 depicts a right lateral side view of the example Dynamic Multi Axis Mounting Platform System corresponding to FIG. 1 in an embodiment.

FIG. 5 depicts a superior top view of the example Dynamic Multi Axis Mounting Platform System corresponding to FIG. 1.

FIG. 6 depicts an inferior bottom view of the example Dynamic Multi Axis Mounting Platform System corresponding to FIG. 1 in an embodiment.

FIG. 7 depicts an isometric view of the example Dynamic Multi Axis Mounting Platform System (stand-alone) showing the swing jacks in a raised un deployed position in an embodiment.

FIG. 8 depicts an example of a lateral back view showing an example of the Dynamic Multi Axis Mounting Platform System corresponding to FIG. 1 as the Dynamic Multi Axis Mounting Platform System(s) may be connected to two (2) parallel I-beams supported by columns in an embodiment.

FIG. 9 depicts a right lateral side view of Dynamic Multi Axis Mounting 10 Platform corresponding to FIG. 1 as the Dynamic Multi Axis Mounting Platform System may be connected to two (2) parallel I-beams supported by columns in an embodiment.

FIG. 10 is an example of a lateral side view of “multiple” Dynamic Multi Axis Mounting Platform Systems corresponding to FIG. 7 of the dynamic multi axis with multiple outriggers, receiver hitch couplers, receiver hitch couplers with mounting plates, and expansion plates is connected to a horizontal surface Dynamic Multi Axis Mounting Platforms System corresponding to that depicted in FIG. 7 in an embodiment.

FIG. 11 depicts an example of a superior top view and a corresponding lateral side view of an example expansion plate and may be welded or bolted to the example Dynamic Multi Axis Mounting Platform System horizontal or vertical surfaces as depicted in the embodiment shown in FIG. 10 and all receiver hitch couplers as depicted in FIGS. 15-21 in accordance with various embodiments.

FIG. 12 depicts an example of the left lateral side view of the vertical/horizontal clevis swing plate assembly corresponding to FIGS. 1-6 Dynamic Multi Axis Mounting Platform System in an embodiment.

FIG. 13 depicts an example superior top view of an example vertical/horizontal clevis swing plate assembly corresponding to that depicted in FIGS. 1-6 of the example Dynamic Multi Axis Mounting Platform System illustrating operation thereof in an embodiment.

FIG. 14 depicts an example of the upper and lower swing plate assembly front lateral sides as welded to superior surface mounting plate, corresponding to that depicted in FIG. 13 as the Vertical/horizontal clevis swing plate assembly operation thereof and corresponding to the Dynamic Multi Axis Mounting Platform System depicted in FIGS. 1-6 in an embodiment.

FIG. 15 is a cross-sectional view showing an example of the coupler build up receiver hitch pin and safety clip with optional stop nut and bolt assembly, optional anti-rattle device as may be implemented on all receiver hitches tube(s), receiver hitch coupler interconnection(s), (e.g. receiver hitch tube outrigger(s), receiver hitch tube leg(s), receiver hitch tube columns, and interconnection to Dynamic Multi Axis Mounting Platform System(s) and all base plates anchors).

FIG. 16 shows an example of a lateral side view of an example T coupler of the example Dynamic Multi Axis Mounting Platform System in an embodiment.

FIG. 17 shows an example of a left lateral side view and a corresponding superior top view of an example straight coupler with a mounting plate of the example Dynamic Multi Axis Mounting Platform System in an embodiment.

FIG. 18 shows an example of a lateral side view of an example double ended straight coupler of the example Dynamic Multi Axis Mounting Platform Systems as depicted in FIGS. 1-10 as well as to extend receiver hitch tube outriggers, receiver hitch tube legs, and receiver hitch tube columns and other in accordance with an embodiment.

FIG. 19 shows an example of a superior top view and a corresponding left lateral side view of an example base plate/wall mount coupler of the example Dynamic Multi Axis Mounting Platform System depicted in FIGS. 1-6 in an embodiment.

FIG. 20 shows an example of a superior top view of an example outside corner/wall mount coupler of the example Dynamic Multi Axis Mounting Platform System depicted in FIG. 10 in an embodiment.

FIG. 21 shows an example front lateral side view and a corresponding superior top view + plus coupler of the example Dynamic Multi Axis Mounting Platform System depicted in FIG. 10 in an embodiment.

FIG. 22 depicts an isometric view of the example receiver hitch coupler reducer as may be used the example Dynamic Multi Axis Mounting Platform System depicted in FIGS. 1-6 in an embodiment.

FIG. 23 depicts an isometric view of the example anti rattle device as may be used the example Dynamic Multi Axis Mounting Platform System receiver hitch tube outriggers, receiver hitch tube legs, receiver hitch tube columns, of the example Dynamic Multi Axis Mounting Platform System depicted in FIG. 10 in an embodiment.

FIG. 24 depicts an isometric view of the example swing Jack adapted for use in conjunction with the example Dynamic Multi Axis Mounting Platform System depicted in FIGS. 1-6 in an embodiment.

FIG. 25 depicts an example end view and corresponding side view of an example of a receiver hitch tube of the receiver hitch tube outrigger(s), receiver hitch tube leg(s), receiver hitch tube column(s) of the example Dynamic Multi Axis Mounting Platform System depicted in FIGS. 1-6 in an embodiment.

FIG. 26 is an example of the receiver hitch pin and corresponding receiver hitch safety clip required at all receiver hitch tube/receiver hitch coupler interconnection(s) in accordance with an embodiment.

### DETAILED DESCRIPTION

A Dynamic Multi Axis Mounting Platform System is disclosed herein as it may be used on varying surfaces including but not limited to floors, walls, ceilings, or outside including but not limited to underneath structures in yards or connected to walls, roofs, out in fields and is even submersible or other either singly or in combination with multiple Dynamic Multi Axis Mounting Platform Systems coupled together into large systems such as may be used for a commercial solar farm or for a variety of different types of equipment (i.e. structures beam support underneath structures, legs of towers masts, antennas, telecommunications arrays, transmitters, receivers, equipment such as counter stoves, dishwashers, furnishings such as but not limited to tables, seating areas, resting areas, fixtures such as but not limited to lighting, sinks, and counters) or any combination thereof in accordance with various embodiments.

In an example, at least one (1) Dynamic Multi Axis Mounting Platform System includes at least one (1) mounting platform(s) having at least one (1) receiver coupler and at least one (1) extension arm (e.g. receiver hitch tube outrigger(s) or at least one (1) receiver hitch tube leg(s) or at least one (1) receiver hitch tube column(s)) or any combination of or partial combination of at least one extension arm(s) secured to at least one (1) mounting platform(s) with at least one (1) receiver hitch pin and at least one (1) receiver hitch pin safety clip at all interconnections of at least one mounting platform(s) and at least one (1) extension arm (e.g. receiver hitch tube outrigger(s), or at least one (1) receiver hitch tube leg(s) or at least one (1) receiver hitch tube column(s) or any combination or partial combination thereof and all interconnected with at least one (1) receiver hitch pin and at least one receiver hitch pin safety clip inserted into at least one (1) hole in the end of at least one (1) receiver hitch pin and all of at least one (1) securely interconnected to at least one (1) receiver hitch coupler anchor at least one (1) terminal end of at least one (1) extension arm with at least one (1) receiver hitch pin and at least one (1) receiver hitch pin safety clip inserted into the at least one (1) hole into the end of at least one (1) receiver hitch pin, and securely attached to at least one (1) receiver hitch tube coupler anchor securely connected to at least one (1) vertical or horizontal surface.

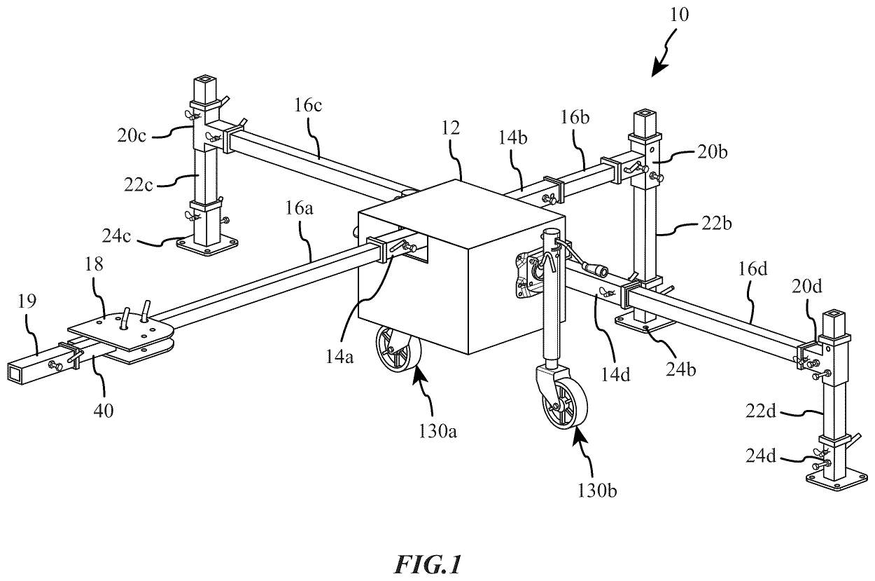

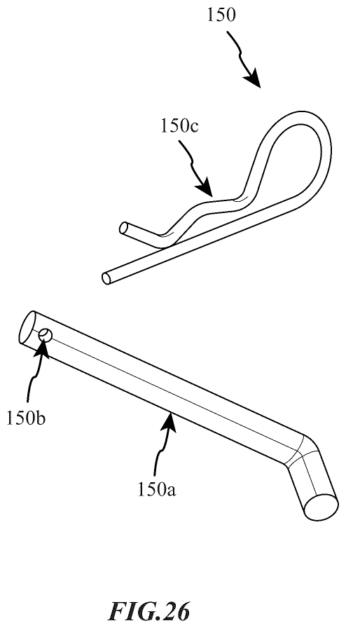

FIG. 1 depicts an example isometric view of an example Dynamic Multi Axis Mounting Platform System with four (4) outriggers 16a-16d connected to (4) receiver hitch tube couplers 14a-14d connected (e.g. welded or bolted or any combination thereof) to the Dynamic Multi Axis Mounting Platform System. The receiver hitch tube outrigger 16 a terminal end connected to vertical/horizontal clevis swing plate assembly 18 with an example receiver hitch anchor connected to terminal end (vertical/horizontal clevis swing plate assembly) 40 with a receiver hitch pin and safety clip FIG. 26 and receiver hitch tube outriggers 16b-16d terminal ends with T couplers 20b-20d and receiver hitch tube legs 22b-22d with baseplate/wall mount couplers 24b-24d and receiver hitch tube legs 22b-22d adjustable in height with swing jacks 130a and 130b deployed and able to level Dynamic Multi Axis Mounting Platform System.

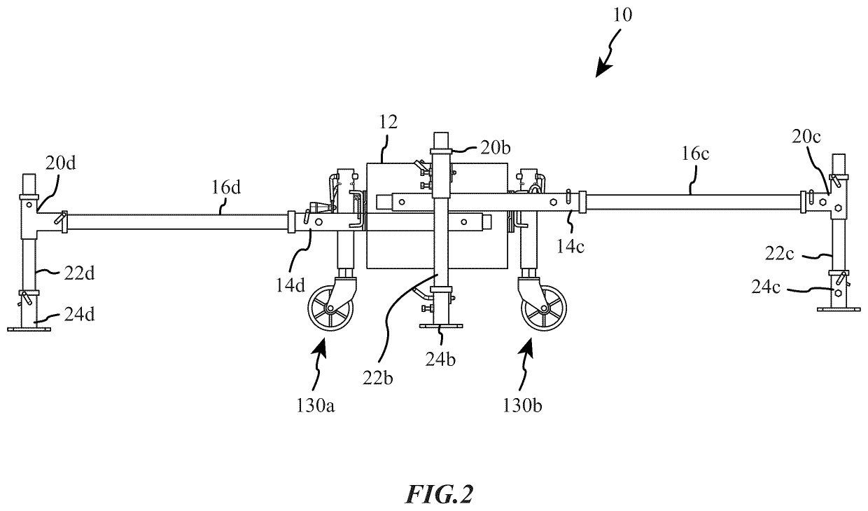

FIG. 2 depicts an example back lateral side view of the example Dynamic Multi Axis Mounting Platform System and corresponding to FIG. 1 of the Dynamic Multi Axis Mounting Platform System.

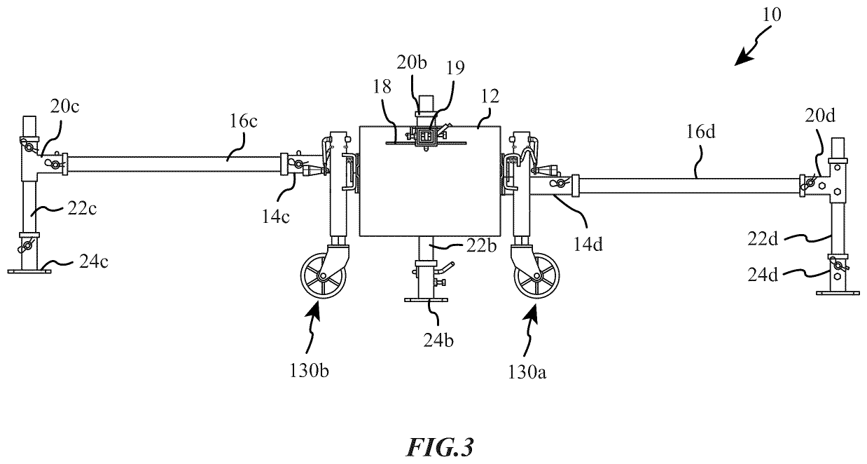

FIG. 3 depicts an example front lateral side view of the example Dynamic Multi Axis Mounting Platform System.

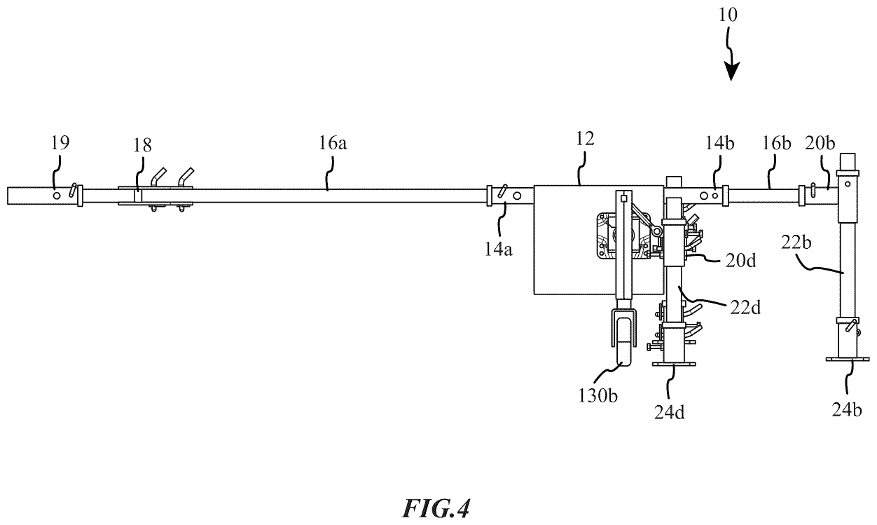

FIG. 4 depicts an example right lateral side view of the example Dynamic Multi Axis Mounting Platform System.

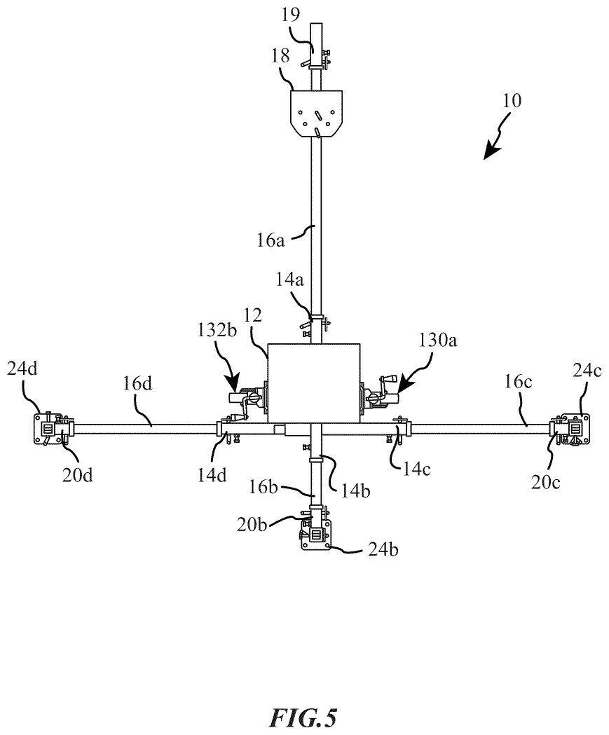

FIG. 5 depicts a top view of an example of the Dynamic Axis Mounting Platform System and corresponding to FIG. 1 of the Dynamic Multi Axis Mounting Platform System.

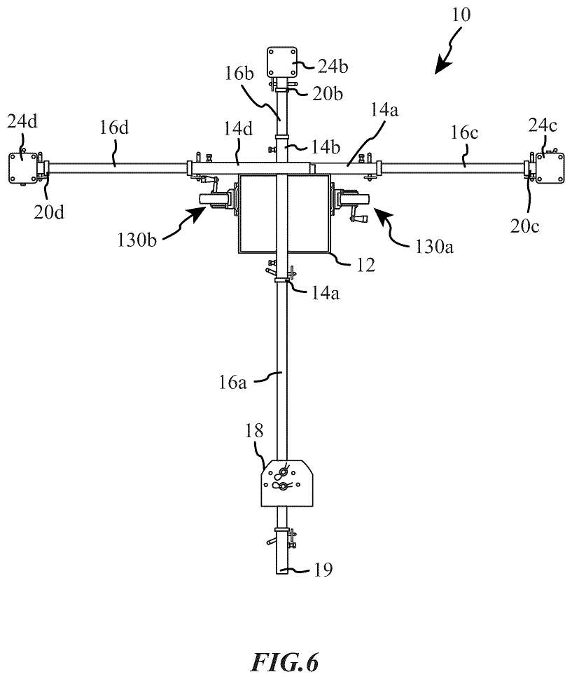

FIG. 6 depicts a bottom view of FIG. 1 an example of the Dynamic Multi Axis Mounting Platform System and corresponding to FIG. 1 of 5 the Dynamic Multi Axis Mounting Platform System.

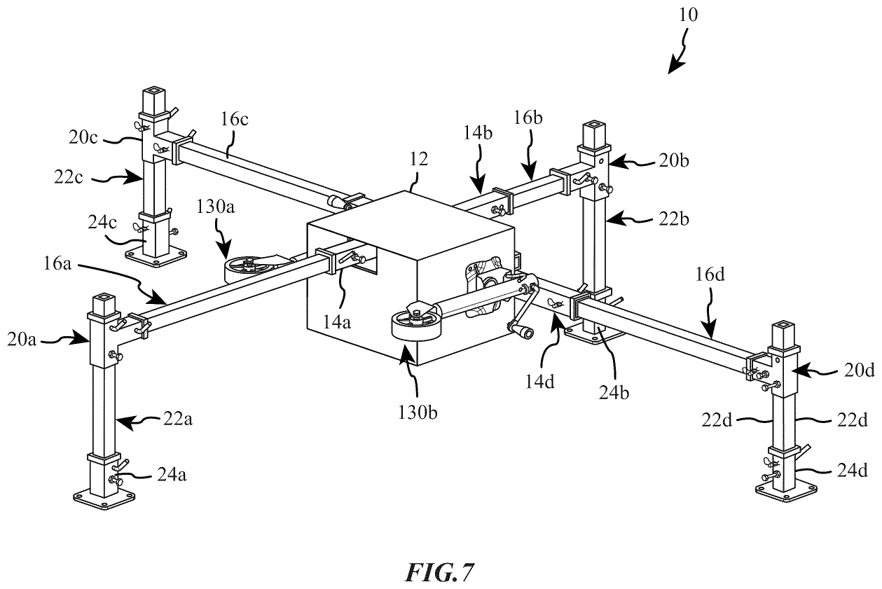

FIG. 7 depicts an example isometric view of the Dynamic Multi Axis Mounting Platform System and corresponding to FIG. 1 showing an exemplary embodiment of the Dynamic Multi Axis Mounting Platform System with (4) four receiver hitch tube outriggers 16a-16d, connected to (4) four T couplers 20a-20d, (4) receiver hitch outrigger leg(s) 22a-22d, with (4) baseplate/wall mount couplers 24a-24d with the swing jacks 130a and 130b in raised position.

By way of non-limiting illustration, solar panels in an exemplary embodiment are mounted on a mast mounted to the Dynamic Multi Axis Mounting Platform System or multiple mounting platforms with masts with a pivotal connection allowing it to rotate and be manually adjusted so the solar panels arrays follow the suns path throughout the day for maximum energy capture. The solar panels in an exemplary embodiment are manually adjusted to point directly towards the sun or alternatively may be electro mechanically automatically adjusted to point at the sun using a photovoltaic eye connected to a electro mechanical gimbal with x and y axis capabilities 360 degrees azimuth and 90 degrees of elevation adjustment using the power generated by the solar panels to operate the electro mechanical motors connected to the gimbal for automatic tracking control thru out the day, thus making the operation almost effortlessly efficient.

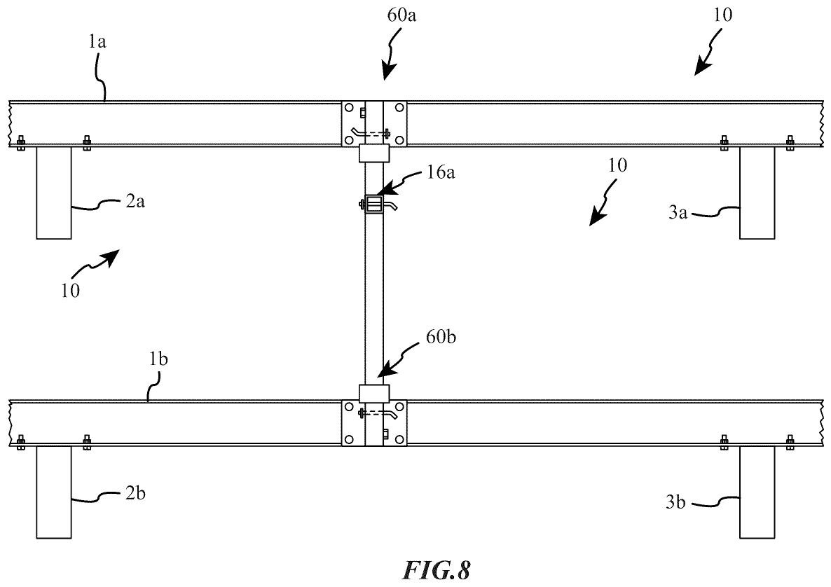

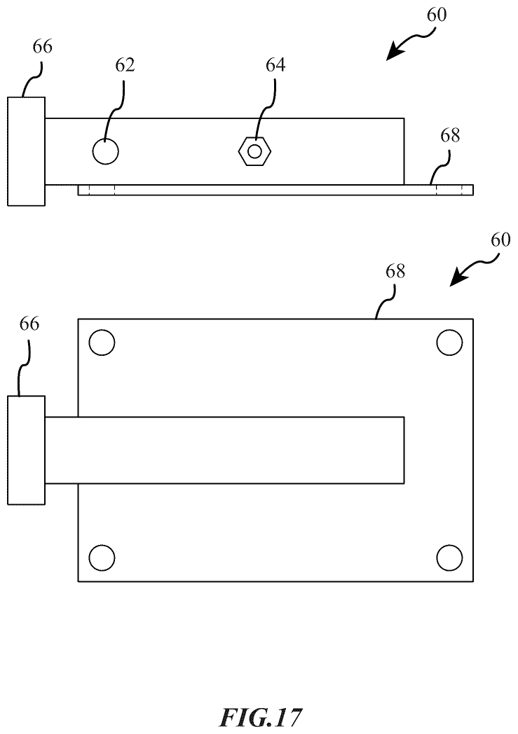

FIG. 8 depicts a back view of an example Dynamic Multi Axis Mounting Platform System in accordance with in an exemplary embodiment as depicted by FIG. 1 with the sole exception that receiver hitch tube outriggers 16a vertical horizontal clevis swing plate assembly 18 is removed from terminal end 16a and replaced with flat plate coupler as shown by FIG. 17, 60a and bolted to top of I beam 1a and outrigger tube 16b, terminal end T coupler 20b, receiver hitch tube leg 22b and base plate/wall mount coupler 24b are removed and replaced with flat strait coupler of FIG. 17, 60b and bolted to top of l beam 1b. This figure depicts a non-limiting illustration of the Dynamic Multi Axis Mounting Platform System as it may attach to two parallel I beams with flat plate straight coupler 60a and 60b bolted on top of I-beams. The remainder of the description is the same as depicted by FIG. 1 in accordance with an embodiment.

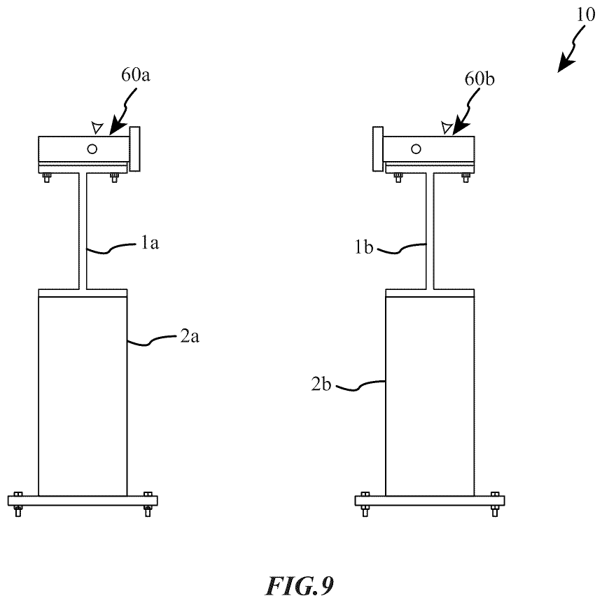

FIG. 9 depicts a side view of an example Dynamic Multi Axis Mounting Platform System embodiment as depicted in FIG. 1 with coupler changes to receiver hitch tube outriggers 16a and 16b as depicted in FIG. 8 as it may attach to two I beams 1a and 1b with flat plate straight couplers as FIG. 17 and shown as 60a and 60b bolted to I beams 1a and 1b. Multiple mounting platforms 10 may attach to the I beams as shown in the exemplary embodiment depicted by FIG. 9.

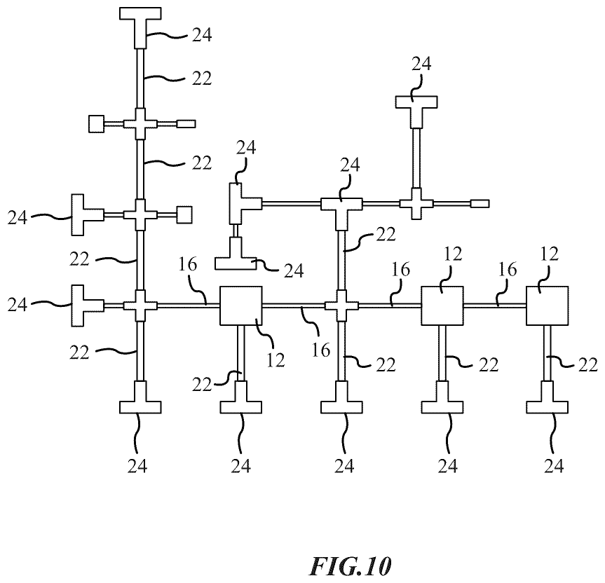

FIG. 10 depicts a non-limiting exemplary embodiment of a side view of the multi Dynamic Multi Axis Mounting Platform System corresponding to the embodiment depicted by FIG. 7 and an example of the receiver hitch tube dynamic used in an exemplary embodiment “both” for structural support of the Dynamic Multi Axis Mounting Platform System as well as to provide multiple mounting platforms 10, as well as, unlimited expansion superiorly, inferiorly, anteriorly and posteriorly to expand exponentially in all directions and/or orientations to provide additional mounting platforms 10 using couplers, couplers with mounting plates, expansion plates or any combination or partial combination thereof, including those embodiments as depicted by FIGS. 1-26 in any combinations and orientations as a structural support for the Dynamic Multi Axis Mounting Platform System, as well as, in accordance with an embodiment a distribution center for mounting structures equipment, appliances, and furnishings such as, but not limited to counters, tables, cabinets, resting places, chairs and fixtures including but not limited to lights, sinks, bathtubs, wash tubs inside and outside on to or underneath of these multiple mounting surfaces at different heights and orientations.

In an exemplary embodiment as depicted by FIG. 10, the outrigger leg 16a-16d as it may be modified to support multiple Dynamic Multi Axis Mounting Platform Systems as well as receiver hitch tube legs 22a-22d as well as any and or all receiver hitch couplers, receiver hitch couplers with mounting plates, receiver hitch tubes for mounting platforms, for dynamic expansion in all directions, and orientations Dynamic Multi Axis Mounting Platform System receiver hitch tube outrigger in between the primary Dynamic Multi Axis Mounting Platform System and terminal ends of outrigger(s) 16a-16d, adjustable leg(s) 22a-22d, column(s) made by extending leg(s) to mount to two (2) horizontal surfaces using baseplate/wall mount adapters and in an exemplary embodiment in combination with the embodiments depicted by FIG. 1-26, which in an example comprises couplers with mounting plates.

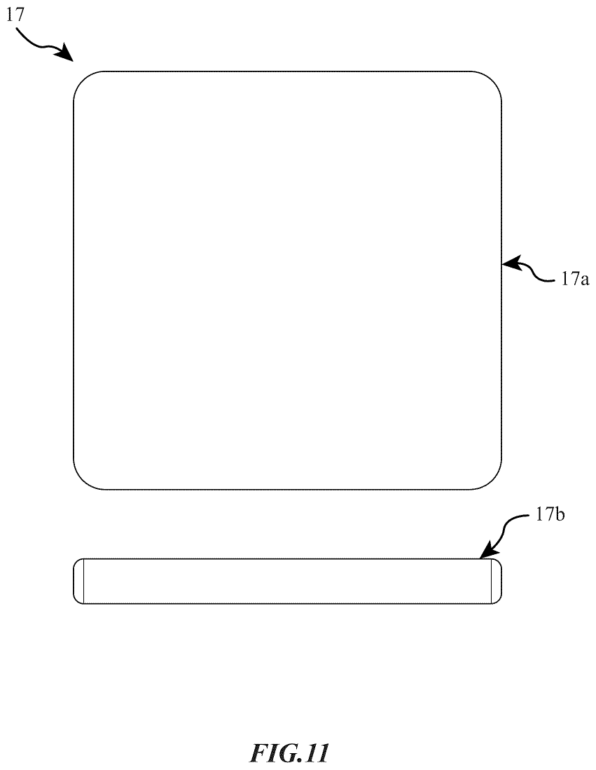

FIG. 11 depicts a top view and corresponding side view of an example expansion plate in an embodiment. FIG. 11 depicts an expansion plate as may be installed over the top mounting surface 12 of the mounting platform over the vertical or horizontal mounting surface(s) on the Dynamic Multi Axis Mounting Platform System or a receiver hitch coupler with or without mounting plate to increase the dimensions of the mounting surface to provide a larger mounting surface for loads being mounted on the mounting platform or receiver hitch coupler.

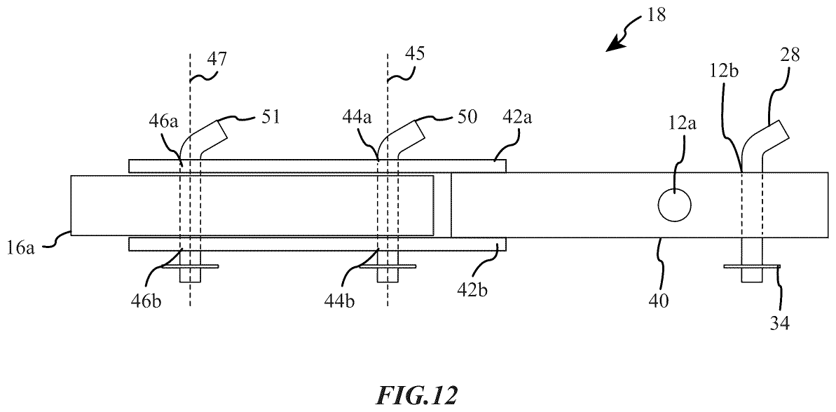

In accordance with an exemplary embodiment, FIG. 12 depicts a vertical/horizontal clevis swing plate assembly 18 as intended to be used in coordination with the Dynamic Multi Axis Mounting Platform System which includes a mounting arm 40 for connection to the anchor 19. An upper lock plate 42a is rigidly connected to an upper portion of the mounting arm 40 (e.g. by welding or bolts). A lower lock plate 42b is rigidly connected to a lower portion of the mounting arm 40 (e.g., by welding or bolts). A first pivot opening 44a is formed through the upper lock plate 42a and axially aligned (illustrated by line 45 in FIG. 12) with a first pivot opening 44b formed through the lower lock plate 42b. A plurality of selectable pivot openings 46a-e is formed through the upper lock plate 42a and axially aligned (illustrated by line 47 in FIG. 12) with corresponding selectable pivot openings (46b corresponding to opening 46a is visible in FIG. 12) formed through the lower lock plate 42b.

In an exemplary embodiment, a vertical/horizontal clevis swing plate assembly mounted in a horizontal operating position enables the Dynamic Multi Axis Mounting Platform System to be pivoted about the anchor between a close position and at least one operating position by moving the Dynamic Multi Axis Mounting Platform System and the receiver hitch tube outrigger that is connected to the vertical/horizontal clevis swing plate assembly between any of the predefined positions, horizontal or vertical in swing plate assembly orientation. For example, the mounting platform may be moved into any of the open positions (at any desired angle) perpendicular to a wall for operation of and use of the equipment, appliances, or other mounted to the Dynamic Multi Axis Mounting Platform System and the Dynamic Multi Axis Mounting Platform System may be moved into a close position parallel to the wall or other vertical surface for out of the way storage.

FIG. 12 depicts a top view of an example vertical/horizontal clevis swing plate assembly 18 of the example Dynamic Multi Axis Mounting Platform System 10 illustrating operation thereof. FIG. 12 is a side view of the example swing plate assembly 18 corresponding to FIGS. 1-6. The vertical/horizontal clevis swing plate assembly 18 shown in FIGS. 1-6 is referred to herein as a vertical/horizontal clevis swing plate assembly.

The example vertical/horizontal clevis swing plate assembly 18 is pivotable between a plurality of predefined pivot positions. As such the mounting platform 12 is pivotable about the anchor 19 between an open position (e.g. perpendicular to the vehicle bumper for transport to at least one operating position (e.g., extended from the vehicle or wall). This can be accomplished by moving the outrigger arm 16a connected to the vertical/horizontal clevis swing plate assembly 18 between the predefined pivot positions illustrated by way of an example in FIG. 12.

In accordance with an exemplary embodiment, in association with the vertical/horizontal clevis swing plate assembly 18, the unique swing capability of the vertical horizontal clevis swing plate assembly 18 allows the receiver hitch tube outrigger or other receiver hitch tube on the Dynamic Multi Axis Mounting Platform System to swing horizontally or vertically 180 degrees in the horizontal position riding on the wheels of the swing jacks when the mounting platform 10 and the mounted load are lifted off the primary and secondary outriggers and the adjustable legs raised, again the vertical/horizontal clevis swing plate assembly can be detached and rotated 90 degrees and reattached to the receiver hitch anchor allowing the now vertical position horizontal clevis swing plate assembly to swing 180 degrees in a vertical swing position. This unique capability allows for virtually unlimited positioning vertically as well as horizontally for the Dynamic Multi Axis Mounting Platform System and the equipment mounted to the mounting platform 12. More than one vertical/horizontal clevis swing plate assembly can't be mounted on a receiver hitch outrigger tube to the opposing terminal ends or other, each in the same horizontal or vertical swing operating position or alternatively one vertical/horizontal clevis swing plate assembly can be orientated in a vertical swing orientation and the other vertical/horizontal clevis swing plate assembly on the opposing terminal end of a receiver hitch tube can be orientated in a horizontal swing position allowing for even more possibilities with both vertical and horizontal adjustment capabilities. The lock pin and safety clip in accordance with an exemplary embodiment may then be installed to lock those positions into place, preventing movement until such time as the end-user removes the pin allowing for free swing in any orientation. In accordance with an exemplary method of use, the above steps may again be performed to position either to a defined position or an undefined position. In an undefined position, in accordance with an intended method of use, a new hole must be drilled through the upper swing plate assembly and the corresponding lower swing plate to provide a new defined at the desired angle position established with the ability to lock the swing plate and the mounting platform into that newly established position when reinstalling the receiver hitch pin and safety clip through the upper lock plate, the receiver hitch tube, and lower lock plate and installing a safety clip.

In an exemplary embodiment, a vertical/horizontal clevis swing plate assembly connect to one of the plurality of receiver hitch tube outriggers that extends from the mounting platform, the vertical/horizontal clevis swing plate assembly is pivotable between a plurality of predefined as well as undefined positions in a horizontal swing orientation “or” a vertical swing orientation by rotating the vertical/horizontal clevis swing plate assembly 90 degrees and re-attaching to the anchoring receiver hitch coupler anchor(s) and vertical/horizontal swing plate assembly and receiver hitch tube outrigger to the dynamic multi axis equipment mounting platform with the vertical/horizontal clevis swing plate assembly. The Dynamic Multi Axis Mounting Platform System in an embodiment is connected to any suitable anchor including but not limited to any stationary object (e.g. a wall, a building, a vehicle, RV truck, or other vehicles). In accordance with various embodiments and methods of use, the receiver hitch tube/receiver hitch couplers interconnection(s) are securely pinned with receiver hitch pins and safety clips.

In an exemplary embodiment, a vertical/horizontal clevis swing plate assembly mounted in a horizontal operating position enables the mounting platform to be pivoted about the anchor between a close position and at least one operating position by moving the Dynamic Multi Axis Mounting Platform System and the receiver hitch tube outrigger that is connected to the vertical/horizontal clevis swing plate assembly between any of the predefined positions, horizontal or vertical in swing plate assembly orientation. For example, the mounting platform in an example is moved into any of the open positions (at any desired angle) perpendicular to a wall for operation of and use of the equipment, appliances, or other mounted to the mounting platform and the mounting platform may be moved into a close position parallel to the wall or other vertical surface for out of the way storage.

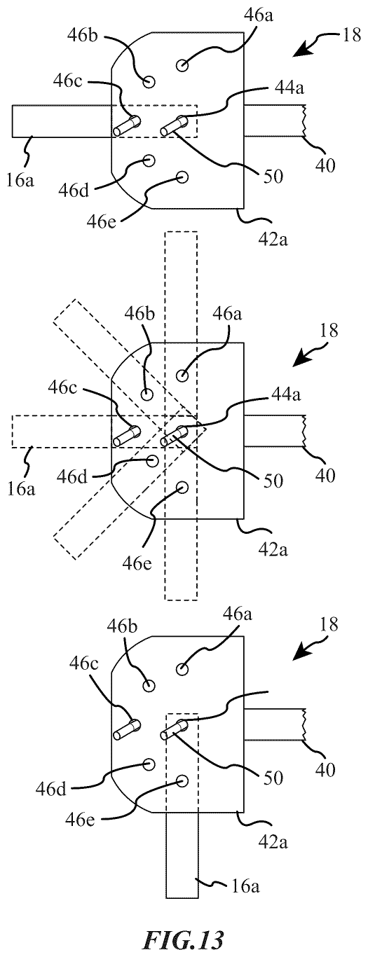

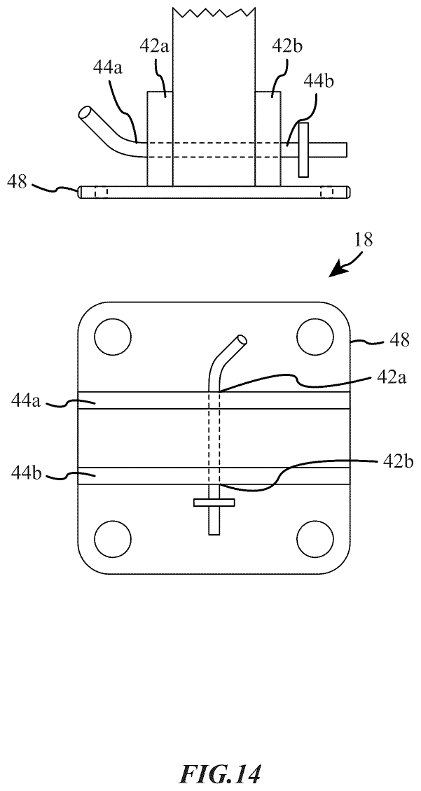

FIG. 14 depicts an exemplary embodiment of the upper and lower swing plate assembly corresponding to the exemplary embodiment depicted by FIGS. 12-13 welded to a mounting plate with the same operational characteristics as that embodiment depicted by FIGS. 12-13 and mounted to vertical and/or horizontal surfaces for connecting extension arms (e.g. receiver hitch tube outrigger(s), receiver hitch tube leg(s), receiver hitch tube column(s) or any combination or partial combination thereof the Dynamic Multi Axis Mounting Platform System.

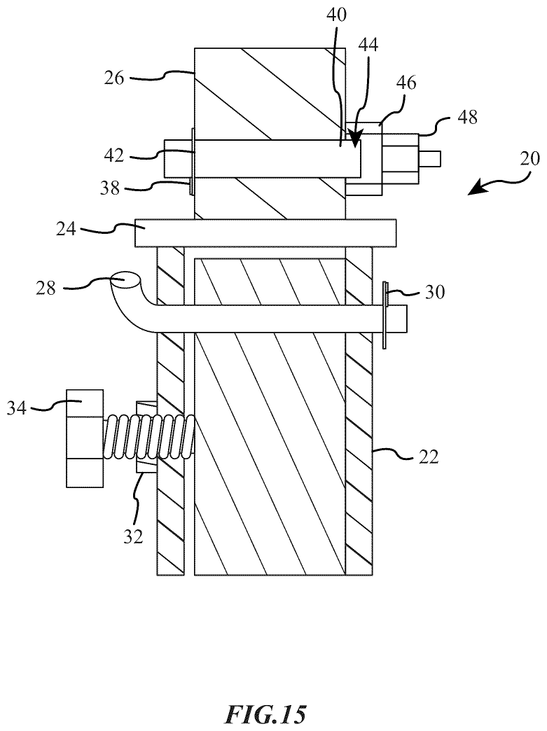

FIG. 15 depicts a cross-sectional view showing an example receiver hitch pin and safety clip and stop bolt interconnection 20 of the example Dynamic Multi Axis Mounting Platform System. The interconnection 20 can be used with any receiver hitch portion 22, such as that of receiver couplers with mounting plates, etc. example Dynamic Multi Axis Mounting Platform System. Standard setbacks for receiver hitch pin holes from face of receiver hitch, as well as standard setback requirements for receiver hitch pin holes terminal ends of receiver hitch tubes to minimum standard setbacks example pin and stop bolt interconnection 20 for holes are also included. In an example, a stop bolt 34 can be threaded through the receiver portion 22 (e.g., through nut 32 welded thereon) so that it presses up against the arm portion 22 and presses the arm portion 22 against the opposite side of the interior of the receiver portion 22 as shown in FIG. 15. This helps to secure the arm portion 26 within the receiver portion 22, e.g. to prevent vibration, shaking or rattling therein and making the interconnection more stable when combined with the receiver hitch pin 28 and safety clip 30. It is noted that the pin and stop bold interconnection 26 may be provided on any side in accordance with an exemplary embodiment (and even on more than one side) and/or top and/or bottom of any receiver element. For example the pin and stop bolt interconnection would typically be provided on one side of a receiver element. That is, the pin and stop bolt interconnection 26 may be provided on the left side or the right side of a receiver hitch coupler. But in other examples, the pin and stop bolt interconnection 26 may be provided on the top (e.g. to provide easier access for the user), and even on the bottom (e.g., where the top cannot be readily reached).

An exemplary embodiment comprises a receiver hitch pin stop bolt innerconnection 20 of any receiver hitch tube coupler and terminal end minimum distance from face of receiver hitch to center of hole to accept receiver hitch pin, and minimum setback distance for receiver hitch pin holes in terminal end of all receiver hitch tube or bar stock entering receiver hitch couplers. This includes minimum distance requirements between additional holes in between terminal ends vertical or horizontal per receiver hitch pin installed on the receiver hitch tube outriggers, legs, columns, and short extension arms. The minimum set back standards a minimum distance between holes installed on receiver hitch tubes should be strictly maintained and followed to maintain structural integrity and support capabilities of the Dynamic Multi Axis Mounting Platform System as a structural support platform and mounting system in accordance with an exemplary embodiment.

In an accordance with an embodiment, the receiver hitch coupler minimum set back standards of receiver hitch pin holes and receiver hitch tube, as measured from base of the receiver hitch to the center of the hole for the receiver hitch, comprise the following:
1¼ inch−1½ inch on center setback from face of collar to center off receiver hitch pin hole and 9/16 in hole receiver hitch pin with safety clip.
2 inches=2½ inch on center from face of receiver hitch collar 4 to center of hole with ⅝-inch receiver hitch pin and safety clip.
2½ inch receiver hitch=2½ inch on center from face of collar to center of ⅝ inch hole with ⅝-inch receiver hitch pin and safety clip.
3-inch receiver hitch+2½ inch set back on center to center if ⅝-inch hole 4 with receiver hitch pin and safety clip.

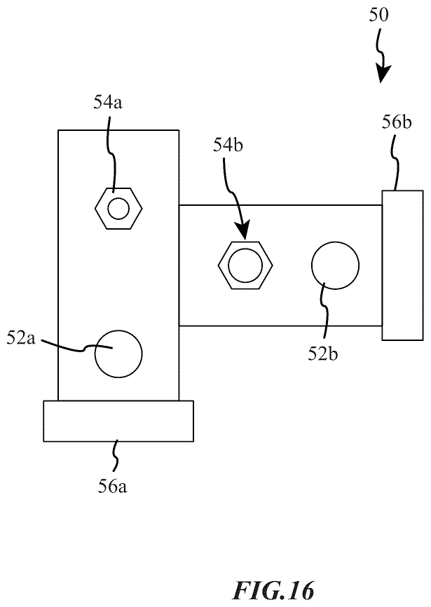

FIG. 16 depicts an example side view of T coupler. The T coupler 50 includes receiver hitch pin holes 52a and 52b, welded nuts 54a and 54b, and collars 56a and 56b, and may be used in any position in association with the Dynamic Multi Axis Mounting Platform System as necessary.

FIG. 17 depicts a side view and corresponding top view of an example flat plate straight coupler 60. The example flat plate coupler 60 includes a thru hole 62 for a receiver hitch pin and safety clip, a welded nut 64, a collar 66, and a mounting plate 68 and may be used in any position as useful to assemble the Dynamic Multi Axis Mounting Platform System.

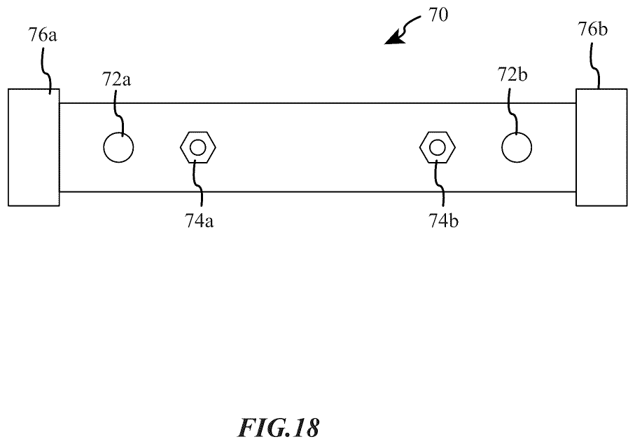

FIG. 18 depicts an example side view of the example double end straight coupler. The double end straight coupler includes a receiver hitch pin hole 72a, 72b for a receiver hitch pin and safety clip, welded nuts 74a, 74b, and a collars 76a, 76b and may be used in any position necessary as useful to assemble the Dynamic Multi Axis Mounting Platform System.

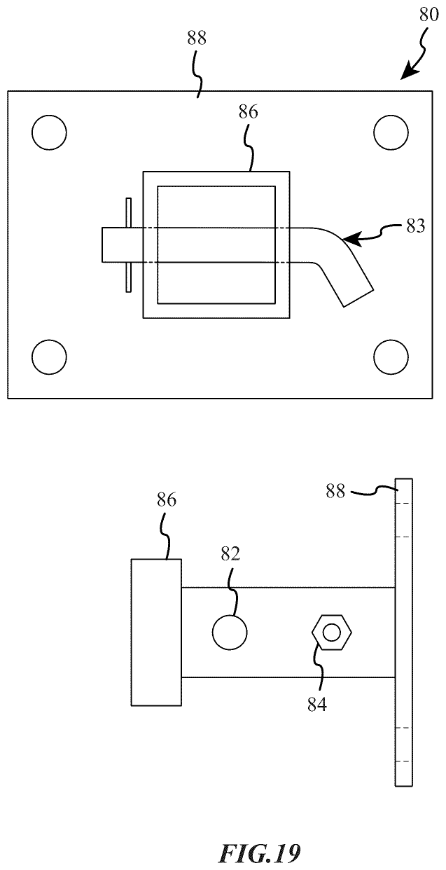

FIG. 19 depicts a top view and corresponding side view of an example baseplate/wall mount coupler 80 of the example of the Dynamic Multi Axis Mounting Platform System. The wall mount baseplate/coupler 80 includes a through hole 82 for a receiver hitch pin and safety clip 83 a welded nut 84, a collar 86 and a mounting plate 88 welded to the back of the coupler to attach to flat surfaces and may be used in any position necessary to assemble the Dynamic Multi Axis Mounting Platform System.

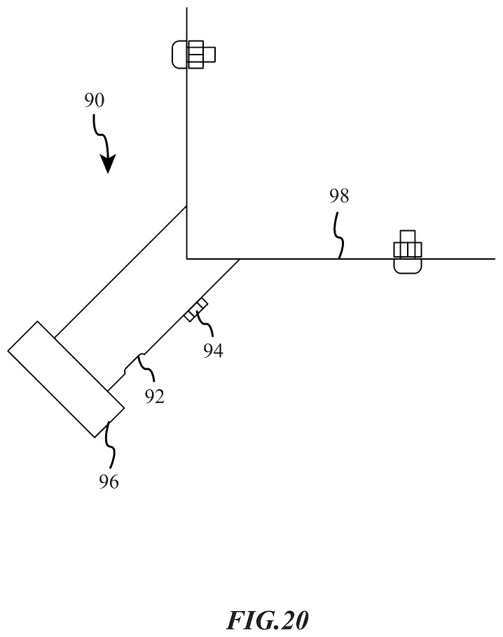

FIG. 20 depicts a top view of an example outside corner wall mount coupler 90 with mounting plate the wall mount adapter 90 includes a through hole 92 for a receiver hitch pin and safety clip, a welded nut 94, a collar 96, and a corner wall mount plate 98 and may be used in any position necessary as useful to assemble the Dynamic Multi Axis Mounting Platform System.

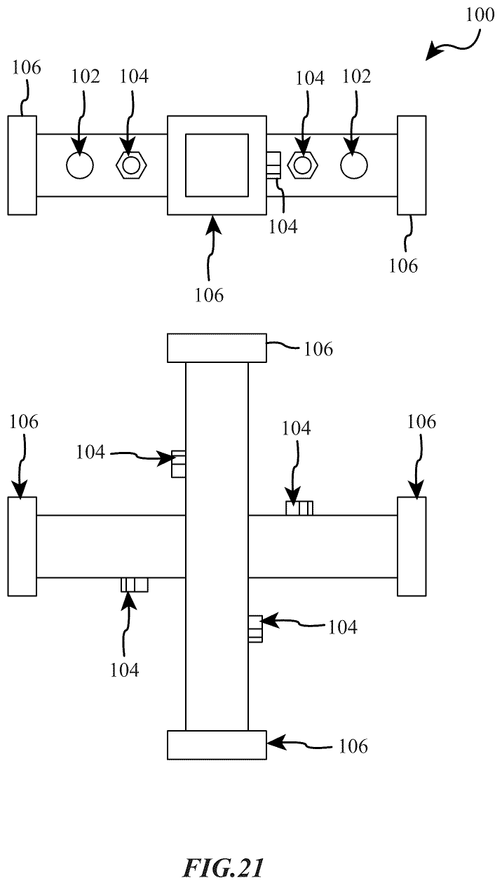

FIG. 21 depicts a side view of an exemplary embodiment of a + plus couple. The + plus coupler comprises receiver hitch pin holes 102a-102d for a receiver hitch pin and welded nuts 104a-104d and callers 106a-106d of the Dynamic Multi Axis Mounting Platform System.

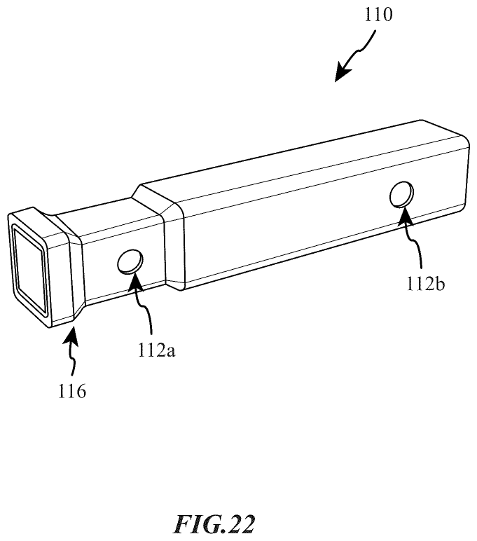

FIG. 22 depicts an example isometric view receiver hitch coupler reducer. The receiver hitch coupler in an embodiment comprises a through hole 112 for a receiver hitch pin and safety clip, a reducer attachment pin hole 114 for coupler and collar 116 and may be used in any position necessary to reduce any coupler(s) to the next smaller size (i.e. 3″-2.5″, 2.5″-2″, 2″-1¼″) in association with the Dynamic Multi Axis Mounting Platform System.

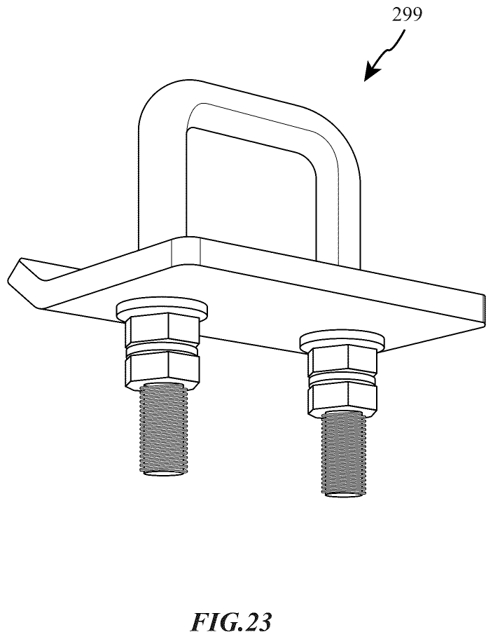

FIG. 23 depicts an exemplary embodiment of an anti-rattle device 299, configured to prevent rattling in accordance with an embodiment. The optional anti-rattle device 299 in accordance with an exemplary embodiment is used if deemed necessary during production or by the end user as required for dynamic configuration of the Dynamic Axis Mounting Platform System.

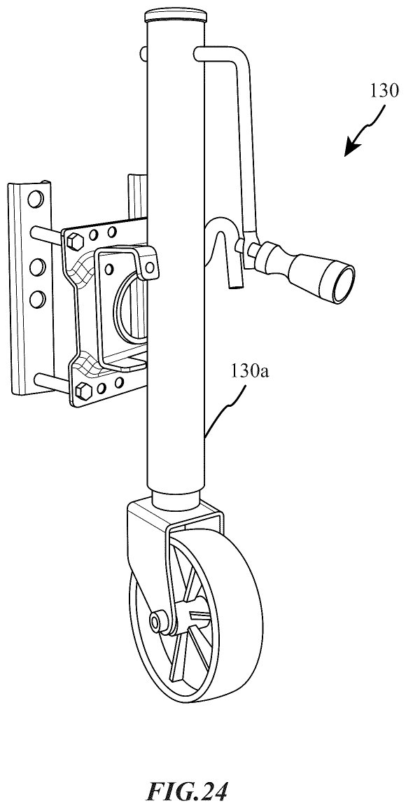

FIG. 24 depicts a swing jack 130 of utilized in association with an exemplary embodiment of the Dynamic Multi Axis Mounting Platform System. In accordance with the example depicted in the figures, two (2) swing jacks 130a and 130b are shown by way of illustration on the mounting platform 10. However, any number of swing jacks may be provided in accordance with an embodiment. The example swing jack 130a shown in FIG. 1 facilitates movement of the mounting platform 10 to at least one operating position before deploying the receiver hitch tube outriggers or receiver hitch tube legs 22b-22d to support the mounting platform 10. The swing jack or jacks are provided for lifting and leveling the mounting platform as well as assisting in stabilizing the platform and providing lateral swing capabilities for the mounting platform and the load mounted on the platform swing jacks as shown in FIG. 1 may be used as well as other configurations of mechanical swing jacks. In an exemplary embodiment, if required, the mounting platform may be retrofitted with hydraulic ram jacks if necessary to lift substantial weight. These lifting jacks in any configuration may be installed to the terminal ends of receiver hitch tube outrigger arms 16a-16d in place of adjustable receiver hitch tube legs 22a-22d with base plate/wall mount couplers 24a-24d if desired, by attaching a base plate wall mount coupler 24a-24d to the terminal end or ends of the receiver hitch tube outriggers 16a-16d then bolting or welding the swing jacks to the base plate/wall mount couplers 24a-24d. In accordance with an embodiment, the adjustable receiver hitch tube legs 22a-22d are replaced with swing jacks also allowing for leveling to take place not at the mounting box but at the receiver hitch tube outriggers with swing jacks attached to them. The caster wheels mounted to the bottom of swing jacks in accordance with an exemplary embodiment are retrofitted with a foot plate replacing the wheel for stationary applications. In accordance with various embodiments, the one or more swing jack(s) are mounted and used on many of the Dynamic Multi Axis Mounting Platform System configurations. In accordance with an embodiment, the swing jacks are removable from the Dynamic Multi Axis Mounting Platform System if they are not necessary, for example being used on surfaces such as walls or ceilings where the swing jack is of no benefit in association with an exemplary embodiment comprising the four (4) receiver hitch tube outriggers attached to the mounting platform 10 and four (4) T couplers 20a-20d attached to the terminal ends of the receiver hitch tube outriggers 16a-16d and receiver hitch tube legs 22a-22d attached to base plate wall mount adapters 24a-24d then mounting to the wall or ceiling. In stationery applications as an example the swing jacks may be removed. The mechanical swing jacks may be replaced with hydraulic swing jacks if necessary for heavier applications with more substantial loads and platform 10 configurations.

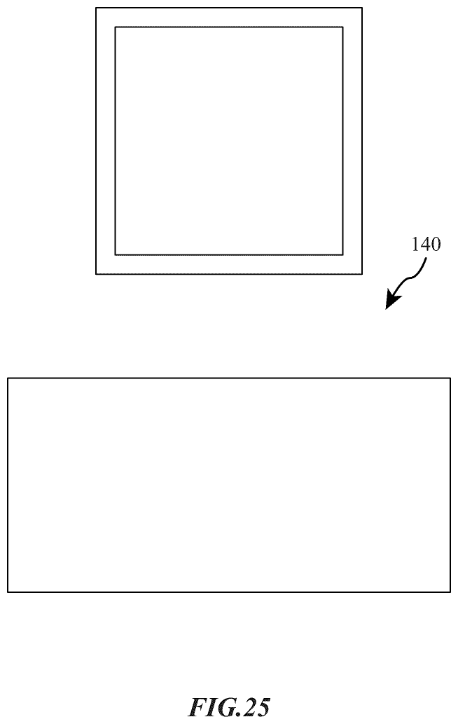

FIG. 25 depicts an example end view and a corresponding side view of the receiver hitch tube as used to manufacture all extension arms (e.g. receiver hitch tube outrigger(s), receiver hitch tube leg(s), receiver hitch tube column(s)) in accordance with an exemplary embodiment of the Dynamic Multi Axis Mounting Platform System.

FIG. 26 depicts an example of a receiver hitch pin 150 with hole 150a and corresponding safety clip 150b as used at all receiver hitch tube/receiver hitch coupler interconnections without exception and corresponding to FIG. 15 interconnection protocols in accordance with an exemplary embodiment of the Dynamic Multi Axis Mounting Platform System.

In an embodiment of the Dynamic Multi Axis Mounting Platform System comprising a + coupler configuration using the same or similar components as depicted in FIGS. 1-26 may be box shaped with a top surface with two (2) sets of opposing side surfaces with two (2) opposing side surfaces connecting the first two (2) opposing side surfaces and all side surfaces connected providing structural support to the top surface of this configuration of the Dynamic Multi Axis Mounting Platform System. In an embodiment, the large + coupler as depicted by FIG. 21 is welded to the underneath of the top of the Dynamic Multi Axis Mounting Platform System with the terminal ends of the plus couplers extending centrally beyond the sides of the box on four (4) sides providing access to the receiver hitch pin holes 14a-14d as well as the stop nut and bolt assembly for mounting outrigger tubes and additional couplers. The two sets of opposing side surfaces in an exemplary embodiment provide multiple locations for mounting the swing jacks for unique leveling capabilities as well as additional locations to mount additional couplers if necessary as well as other items deemed necessary by engineering. These Dynamic Multi Axis Mounting Platform Systems in various embodiments comprise the capability to accommodate multiple Dynamic Multi Axis Mounting Platform Systems mounted between each Dynamic Multi Axis Mounting Platform System and the terminal ends of outrigger tubes along the entire length of each and every outrigger tube as well as multiple couplers with or without mounting plates or any combination thereof to provide additional Dynamic Multi Axis Mounting Platform Systems linked together in any orientation with couplers in any orientation to attach Dynamic Multi Axis Mounting Platform Systems to or extend any linked Dynamic Multi Axis Mounting Platform System vertically and/or horizontally along the entire length of tube, as well as terminal end couplers for legs and base plates or double ended couplers allowing to extend the outrigger tube indefinitely in all directions for other Dynamic Multi Axis Mounting Platform System configurations allowing for unlimited expansion and configurability and reconfigurability of the Dynamic Multi Axis Mounting Platform System. Additional receiver hitch couplers of any configuration including as depicted in FIGS. 16-22 may also be added to the Dynamic Multi Axis Mounting Platform System in any and all positions available in accordance with various embodiments of the invention.

In accordance with an exemplary embodiment of the invention, the + plus coupler as depicted in an example by FIG. 21 that may mount underneath the Dynamic Multi Axis Mounting Platform System is flat welded directly underneath the surface of the top of the mounting platform with four (4) sides with the terminal ends of the + plus coupler extending beyond the four (4) sides 14a-14d of the box to allow for access to the receiver hitch pin holes for installing receiver hitch pins 150a-c as shown by FIG. 26 to securely attach the outrigger tubes and access to the stop nut and bolt assembly. The mounting platform in the configuration of the Dynamic Multi Axis Mounting Platform System with four (4) side surfaces and top mounting surface 12 is not limited by width, length, depth or thickness of materials used.

In another exemplary embodiment, the Dynamic Multi Axis Mounting Platform System(s) in any of the above described configurations may comprise the + plus coupler configured in a step configuration using two double ended straight couplers as depicted in an example by FIG. 18 and laid centrally and perpendicular to each other and welded together where the two (2) double end straight couplers bisect each other central and then welding in the bottom surface of the top mounting surface of the Dynamic Multi Axis Mounting Platform System and extend outwardly in four (4) directions with the terminal ends of the step + plus coupler 14a-14d extending beyond the sides of the box on all four (4) sides for access to the receiver hitch pin hole for installing a receiver hitch pin and safety clip as depicted in an example by FIG. 15, as well as to the stop nut and bolt assembly beyond the four (4) sides of the Dynamic Multi Axis Mounting Platform System for use with structures, buildings, appliances furnishing or fixtures mounted to the surface(s) of the Dynamic Multi Axis Mounting Platform System. In an exemplary embodiment, an expansion plate as depicted in an example by FIG. 11 may be bolted to or welded to the top surface (e.g. to enlarge the top surface) referred to as an expansion plate. The specific configuration of the Dynamic Multi Axis Mounting Platform System in various embodiments will depend at least to some extent on design considerations such as but not limited to engineering and/or the end users desires and/or requirements and may be in any shape or size (i.e. round with a flat top surface, square with a flat top surface, rectangular with a flat top surface), or any teaching herein. In accordance with an embodiment, the Dynamic Multi Axis Mounting Platform System comprises multiple Dynamic Multi Axis Mounting Platform Systems mounted and connected with receiver hitch tubes, as well as multiple Dynamic Multi Axis Mounting Platform Systems installed on each receiver hitch outrigger between the terminal end of the outriggers where the outriggers mount the Dynamic Multi Axis Mounting Platform Systems and opposing terminal end of those outriggers.

In accordance with an exemplary embodiment, a plurality of baseplate/wall mount couplers as shown in FIG. 19 connect with the plurality of receiver hitch tube outriggers connected to the plurality of receiver hitch couplers mounted to the Dynamic Multi Axis Mounting Platform Systems and a plurality of receiver hitch tube legs with foot plates interconnect with the plurality of terminal end couplers the receiver hitch tube legs are adjustable in height and like the rest of the couplers must have a receiver hitch pin and safety clip installed in order to securely attach all couplers and receiver hitch tubes and the Dynamic Multi Axis Mounting Platform Systems together to accommodate different surfaces and operational height requirements of the Dynamic Multi Axis Mounting Platform System and in this particular configuration the receiver hitch tube legs may extend vertically all the way to and attaching to the ceiling with the proper terminal end couplers and then becoming columns which allow for the Dynamic Multi Axis Mounting Platform Systems and the equipment appliances, furnishings, or other items and the platform to be elevated to any position between the floor and the ceiling and safely pinned in that position with pre-defined holes drilled through the receiver hitch tube columns to accommodate the receiver hitch pin and safety clips at any pre-determined defined and established height.

In accordance with an exemplary embodiment, any one of the pluralities of receiver hitch tube outriggers terminal ends may connect directly to a receiver hitch anchor mounted to a wall or other stationary surface for stability of the mounting platform as well as the equipment, appliances, furnishings, or other items mounted to the mounting platform and its outriggers receiver hitch tube legs columns or other or any combination thereof.

The Dynamic Multi Axis Mounting Platform System in an exemplary embodiment is mounted to the bed of a trailer. The mounting platform may then have outriggers 16a-16d extend horizontally and vertically and exponentially in all directions beyond the bed of the trailer, allowing for a dynamic distribution platform with equipment, appliances, furnishings, or any combination thereof extending beyond the surface area of the trailer.

In accordance with an embodiment, the outriggers 16a-16d attached to the Dynamic Multi Axis Mounting Platform System may be configured as shown in FIG. 10 in accordance with an example. In various embodiments, the outriggers 16a-16d are modified or configured as necessary to support the requirements of the end user in accordance with intended methods of use of any or all of the components as shown in FIGS. 1-26 or any portion of such components thereof, while mounted to a trailer.

The Dynamic Multi Axis Mounting Platform System's adaptability allows for multiple mounting platforms to be interconnected along the outriggers, with each connection point secured using receiver hitch pins and safety clips. The outriggers can in accordance with various intended methods of use extend indefinitely from the trailer bed, creating expanded mounting surfaces at various heights and orientations while maintaining structural integrity through the standardized connection methods. Swing jacks 130a and 130b can be utilized for leveling and stabilization of the extended configuration.

The Dynamic Multi Axis Mounting Platform System in an exemplary embodiment comprises the outriggers extended horizontally and vertically and exponentially in all directions beyond the bed of the trailer allowing for a dynamic distribution platform with equipment appliances, furnishings, or any combination thereof extending beyond the surface area of the trailer the extended outriggers attached to the Dynamic Multi Axis Mounting Platform System on the trailer having the extended outriggers additionally supported by receiver hitch tube outrigger legs on the surface where the trailer is located (i.e. a parking lot, a job site, a field or even inside of a structure such as a commercial building). The present inventor has recognized that such configuration results in a variety of possibilities and configurations for construction and connection in accordance with various embodiments. An exemplary configuration is depicted by FIG. 10, but it is contemplated in accordance with the invention that alternative configuration embodiments are intended and used as deemed necessary by the requirements of the end user.

The Dynamic Multi Axis Mounting Platform System in various embodiments comprises adjustable sliding features through its receiver hitch tube configurations. A receiver hitch tube can extend through the mounting platform from one end to another, allowing the box to slide back and forth along its length. When a desired position is reached, the Dynamic Multi Axis Mounting Platform System can be secured by drilling a hole through the receiver hitch tube and installing a receiver hitch pin with safety clip.

The Dynamic Multi Axis Mounting Platform System in an embodiment is configured in a spider-like arrangement, where a receiver hitch tube line extends through the mounting box from one end to another. This configuration enables the box to slide along the receiver hitch tube line, with the ability to be pinned at any desired position through drilling a hole and installing a receiver hitch pin.

The spider configuration maintains all standardized dimensional requirements for receiver hitch connections, including proper setback distances for receiver hitch pin holes from face of receiver hitch. For one and one quarter inch receivers, the setback is one and one half inch on center from terminal end to nine sixteenths inch hole. For two inch receivers, the setback is two and one half inch on center from terminal end to five eighths inch hole. For two and one half inch receivers and three inch receivers, the setback is two and one half inch on center from terminal end.

The system in an embodiment enables configuration through securing receiver hitch couplers to extension arms using standardized connection methods. The receiver hitch tubes maintain specific setback requirements from the face of the receiver hitch coupler and the receiver hitch tube to the center of the hole for the receiver hitch pin and the corresponding safety clip based on receiver size: one and one half inch setback for one and one quarter inch receivers, two and one half inch setback for two inch receivers, and two and one half inch setback for both two and one half inch and three inch receivers. Each interconnection point requires receiver hitch pins and safety clips to maintain structural integrity.

The vertical/horizontal clevis swing plate assembly 18 enables unique movement capabilities. When mounted in a horizontal orientation between extension arm terminal ends and anchors, the assembly allows the platform to swing horizontally 180 degrees while riding on swing jack wheels. The mounting platform and load can be lifted off secondary outriggers with adjustable legs raised for movement.

The system can be locked into defined positions using receiver hitch pins through pre-defined holes in the upper and lower vertical/horizontal clevis swing plate assembly 18 lock plates 42a and 42b. For undefined positions, new holes can be drilled through the upper swing plate and corresponding lower swing plate to establish new defined positions for the second pin 47 to be installed through the upper and lower lock plates 42a and 42b and the corresponding receiver hitch tube 16a thereby locking it into the corresponding position, until such time that the corresponding receiver hitch pin 47 and the corresponding safety clip is removed.

The vertical/horizontal clevis swing plate assembly 18 can be detached from the receiver hitch coupler or anchoring receiver hitch, rotated 90 degrees on its axis, and reattached for vertical movement capabilities. This configuration enables 180 degrees of vertical movement between predefined or undefined positions. The assembly includes a mounting arm 40 for connecting to the receiver hitch anchor 19, with upper lock plate 42a and lower lock plate 42b rigidly connected to provide secure positioning in both planes.

Multiple vertical/horizontal clevis swing plate assemblies can be mounted on a receiver hitch outrigger tube, each in the same horizontal or vertical swing orientation, or alternatively configured with one assembly in vertical orientation and another in horizontal orientation on opposing terminal ends. This provides enhanced positioning capabilities in both vertical and horizontal planes while maintaining secure connections through receiver hitch pins and safety clips.

Each outrigger tube in the spider configuration in a written embodiment can slide past other outrigger tubes, enabling infinite adjustment of leg lengths based on extension requirements. The sliding capability maintains structural integrity through standardized receiver hitch pin and safety clip securing methods at all interconnection points.

The Dynamic Multi Axis Mounting Platform System in various embodiments is manufactured using diverse metal materials including steel, stainless steel, aluminum, brass, copper, and magnesium. The Dynamic Multi Axis Mounting Platform System is not limited to industry standard steel construction, allowing flexibility in metal selection based on specific application requirements.

For composite and alternative materials, the Dynamic Multi Axis Mounting Platform System supports manufacture using reinforced concrete, wood, rock, glass, fiberglass, graphite, and graphene, or any combination thereof. These materials can be implemented either independently or combined with other materials to meet specific structural and environmental requirements.

Surface treatments for the Dynamic Multi Axis Mounting Platform System include multiple protective options. Paint applications can include oil-based paints, latex paints, epoxies, and specialized enamels. These can be applied through standard processes or enhanced through baked-on applications. Additional surface protection options include anodizing, staining, baked-on epoxies, baked-on enamels, powder coats, and baked-on powder coats.

Advanced coating options incorporate glass, graphite, and graphene treatments. These specialized coatings provide enhanced protection for marine and submersible applications while maintaining the Dynamic Multi Axis Mounting Platform System's structural integrity. The material thickness is not limited to any particular specifications, allowing for customization based on load-bearing requirements and environmental conditions.

The Dynamic Multi Axis Mounting Platform System's material composition and surface treatment flexibility enables virtually impervious weather resistance across diverse installation environments. All materials and surface treatments can be selected and combined to optimize performance for specific applications while maintaining standardized connection requirements for receiver hitch components.

The Dynamic Multi Axis Mounting Platform System in accordance with an exemplary embodiment provides comprehensive structural support capabilities for buildings and communication equipment. The Dynamic Multi Axis Mounting Platform in an embodiment is configured to support structural beams underneath buildings. Multiple mounting platforms can be interconnected to create extensive support networks for various structural applications.

For radio transmission towers in accordance with another exemplary embodiment, the Dynamic Multi Axis Mounting Platform's with outriggers 16a-16d with T couplers 20a-20d, receiver, hitch tube legs 22a-22d, and base plate/wall mount couplers 24a-24d can be mounted under each leg of the tower to enable precise positional adjustment. The outriggers that extend from each Dynamic Multi Axis Mounting Platform(s) mounted under each leg may thus reach distances up to twenty feet in each direction, creating an extensive support footprint for enhanced stability. This wide-base configuration provides crucial support for tower installations while maintaining the Dynamic Multi Axis Mounting Platform's.

The structural support configuration maintains all standardized connection requirements in accordance with various embodiments, with receiver hitch pins and safety clips securing each interconnection point. The Dynamic Multi Axis Mounting Platform's expandability enables customized support arrangements through strategic placement of receiver hitch tube outriggers 16a-16d with receiver hitch T couplers 20a-20d attached to receiver hitch tube legs 22a-22d with base plate/wallmount couplers 24a-24d. An exemplary embodiment comprises one or more connection(s) with one or more additional mounting surface(s) as illustrated in an embodiment by FIG. 10.

The Dynamic Multi Axis Mounting Platform in an embodiment may be configured with swing jacks 130a and 130b or hydraulic rams for heavier loads, enabling balanced weight distribution across the support structure. When expanded with multiple platforms, the load-bearing capacity is enhanced through the interconnected network of support points, with each connection point secured by receiver hitch pins and safety clips to maintain structural integrity.

The Dynamic Multi Axis Mounting Platform System in an exemplary embodiment is engineered for both marine and submersible environments, enabling underwater component assembly and equipment mounting. The configuration allows for components to be pinned together with receiver hitch pin(s) and safety clip(s) together underwater, with divers able to position and secure equipment in marine environments. The Dynamic Multi Axis Mounting Platform System maintains its structural integrity and mounting capabilities in submerged conditions, while incorporating all necessary safety features including receiver hitch pins and safety clips at all interconnections.

The Dynamic Multi Axis Mounting Platform in an exemplary embodiment is engineered for specialized military and marine applications, including weapons mounting on naval vessels. The Dynamic Multi Axis Mounting Platform's adaptable configuration enables secure attachment of military equipment to ships through receiver hitch couplers and mounting plates, maintaining structural integrity in marine environments.

For underwater applications, the Dynamic Multi Axis Mounting Platform System features unique assembly capabilities where components can be configured and interconnected by divers beneath the surface. The receiver hitch pin and safety clip design enables secure underwater component assembly, allowing divers to position and snap together system elements for mounting equipment in submerged environments. All interconnection points maintain their structural integrity and securing mechanisms underwater through the standardized receiver hitch pin and safety clip configuration.

The Dynamic Multi Axis Mounting Platform System's marine configuration incorporates corrosion-resistant materials and specialized surface treatments suitable for prolonged exposure to marine environments. When configured for underwater applications, the Dynamic Multi Axis Mounting Platform System maintains its full range of adjustability and expansion capabilities while providing stable mounting solutions for submerged equipment and structures.

In another exemplary embodiment, solar panels are mountable on masts attached to the Dynamic Multi Axis Mounting Platform System with pivotal connections allowing manual rotation. The Dynamic Multi Axis Mounting Platform System Platform thus enables manual adjustment of solar panel arrays to follow the sun's path throughout the day for maximum energy capture. The panels can be manually adjusted to point directly towards the sun, providing optimal positioning for energy generation.

The Dynamic Multi Axis Mounting Platform System supports electro-mechanical automatic adjustment capabilities using a photovoltaic eye connected to an electro-mechanical gimbal with x and y axis capabilities. This configuration enables 360 degrees azimuth and 90 degrees of elevation adjustment. The tracking system utilizes power generated by the solar panels to operate the electro-mechanical motors connected to the gimbal for automatic tracking control throughout the day, creating an almost effortlessly efficient operation.

The Dynamic Multi Axis Mounting Platform System can be configured as multiple Dynamic Multi Axis Mounting Platform Systems interconnected using receiver hitch tubes 16a-16d, enabling placement of solar panels at various elevations and positions. This expandable design allows for extensive solar installations while maintaining the Dynamic Multi Axis Mounting Platform's inherent adjustability. The configuration can accommodate both individual panel installations and larger commercial solar farm arrangements.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A dynamic multi axis mounting platform system comprising:
at least one mounting platform having at least one mounting surface;
at least one receiver hitch coupler mounted to the mounting platform;
the at least one receiver hitch coupler connected to at least one surface of the at least one mounting platform;
at least one extension arm, outrigger, leg, column or any combination thereof connected to the at least one receiver hitch coupler;
at least one receiver hitch pin and safety clip securing the at least one extension arm to the at least one receiver hitch coupler;
wherein the at least one extension arm is configured to support the mounting platform in multiple orientations and further comprising at least one receiver hitch coupler anchor connected to a terminal end of the at least one extension arm.

2. The dynamic multi axis mounting platform system of claim 1, wherein the at least one extension arm further comprises:
at least one receiver hitch tube outrigger;
at least one receiver hitch tube leg; and
at least one receiver hitch tube column.

3. The dynamic multi axis mounting platform system of claim 1, wherein the at least one receiver hitch coupler comprises:
at least one T-coupler;
at least one flat plate straight coupler;
at least one double end straight coupler;
at least one baseplate/wall mount coupler; and
at least one plus (+) coupler.

4. The dynamic multi axis mounting platform system of claim 1, further comprising:
a vertical/horizontal clevis swing plate assembly connected to the at least one extension arm, the assembly enabling 180-degree rotation in both horizontal and vertical planes.

5. A interconnected dynamic multi axis multi-mounting platforms system, comprising:
a plurality of interconnected mounting platforms;
a plurality of extension arms;
the plurality of extension arms optionally further comprising intermediate couplers each optionally comprising intermediate extension arms;
the plurality of interconnected mounting platforms anchored to one or a plurality of receiver hitch coupler(s); and
receiver hitch tube extension arms.

6. The system of claim 5, further comprising:
at least one swing jack mounted to at least one of the mounting platforms;
wherein the swing jack provides leveling and height adjustment capabilities.

7. The system of claim 5, wherein the plurality of receiver hitch tubes and the receiver hitch tube extension arms maintain standardized setback requirements from the face of the receiver hitch couplers and the receiver hitch tube extension arms to the center of the holes from the face of the receiver hitch couplers and the receiver hitch tube extension arms, comprising:
one and one half inch setback for one and one quarter inch receivers;
two and one half inch setback for two inch receivers;
two and one half inch setback for two and one half inch receivers; and
two and one half inch setback for three inch receivers.

8. A standalone dynamic multi axis mounting platform system or dynamic multi axis mounting platform system interconnected with other dynamic multi axis mounting platform systems assembly comprising:
one or a plurality of mounting platform(s);
wherein one or plurality of extension arm(s) each comprising one or a plurality of outrigger(s), one or a plurality of leg(s), one or a plurality of column(s) or any partial combination thereof is connected to and extends from the one or plurality of mounting platform(s);
one or a plurality of coupler(s) connected with a receiver hitch pin and safety clip;
the one or a plurality of coupler(s) comprising one or a plurality of T coupler(s), one or a plurality of flat plate straight coupler(s), one or a plurality of double end straight coupler(s), one or a plurality of baseplate wallmount coupler(s), one or a plurality of outside corner coupler(s), one or a plurality of plus + coupler(s), or any combination or partial combination thereof; and
the one or a plurality of coupler(s) connected to one or more terminal end(s) or between the terminal ends of the at least one extension arm;
the one or plurality of coupler(s) connected to the one or plurality of extension arm(s) connected to one or a plurality of anchor(s).

9. The assembly of claim 8, further comprising:
the one or a plurality of anchor(s) attached to the one or plurality of extension arm(s) mounted; and
the one or a plurality of anchor(s) connecting the one or plurality of extension arm(s) to one or a plurality of vertical and/or horizontal surface(s).

10. A method of configuring a dynamic multi axis mounting platform system comprising:
securing one or a plurality of receiver hitch coupler(s) to one or a plurality of extension arm(s) to form one or a plurality of interconnection(s) of a desired diameter and length with one or a plurality of receiver hitch pin(s) and/or receiver hitch pin safety clip(s).

11. The method of claim 10, further comprising:
moving one or a plurality of dynamic multi axis mounting platform systems about one or a plurality of vertical or horizontal anchor(s); the moving step further comprising
installing the at least one or a plurality of vertical or horizontal clevis swing plate assembly(ies) in a horizontal orientation between a one or a plurality of terminal end(s) of the one or a plurality of extension arm(s) and an anchor attached to the one or plurality of receiver hitch coupler(s);
pivoting the one or a plurality of dynamic multi axis mounting platform systems horizontally about the one or a plurality of vertical or horizontal anchor(s);
locking the one or a plurality of dynamic multi axis mounting platform systems into a position relative to the anchor with the one or a plurality of receiver hitch pin(s) and/or receiver hitch pin safety clip(s) along a horizontal plane;
optionally detaching the vertical/horizontal clevis swing plate assembly in a from the one or a plurality of vertical or horizontal anchor(s) and the one or a plurality of extension arm(s);
rotating vertical/horizontal clevis swing plate assembly 180 degrees to a vertical position;
reinstalling the one or a plurality of vertical or horizontal anchor(s) to the one or a plurality of coupler(s) the one or a plurality of extension arm(s);
moving the one or a plurality of dynamic multi axis mounting platform system(s) along a vertical plane; and
optionally removing the vertical/horizontal clevis swing plate assembly from the one or a plurality of vertical or horizontal anchor(s) attached to the one or a plurality of coupler(s) and the one or a plurality of extension arm(s) and reattaching the one or a plurality of extension arm(s) to an additional one or a plurality of coupler(s).

12. The interconnected dynamic multi axis multi-mounting platforms system of claim 5, wherein the one or plurality of swing jack(s) are mounted on a lateral surface of a mounting platform.

13. The interconnected dynamic multi axis multi-mounting platforms system of claim 5, wherein:
wherein the one or plurality of swing jack(s) are mounted to one or a plurality of coupler(s) connected to four outriggers, providing for leveling of aspects of the interconnected dynamic multi axis multi-mounting platforms system via the terminal ends of the four outriggers.

14. The interconnected dynamic multi axis multi-mounting platforms system of claim 5, wherein:
wherein the interconnected dynamic multi axis multi-mounting platforms system is used on a standalone basis or in combination to support one or a plurality of structure(s) by attaching structural base components of the one or plurality of structure(s) to one or a plurality of top mounting surface(s) of one or a plurality of dynamic multi axis multi-mounting platforms system(s) modified to support the one or plurality of structure(s).

15. The dynamic multi axis multi-mounting platforms system of claim 5, wherein:
the one or plurality of receiver hitch tube(s) and coupler(s) are assemblable underwater for submersible applications.

16. The dynamic multi axis multi-mounting platforms system of claim 5, wherein:
the interconnected mounting platforms are configured to support solar panel arrays;
the solar panel arrays are adjustable to track sun movement.

17. The assembly of claim 8, wherein:
the outrigger tubes extend up to twenty feet in each direction from the mounting platform;
the extended outrigger tubes provide support for tower installations.

18. The dynamic multi axis multi-mounting platforms system of claim 1, wherein:
the mounting platform is attachable to a trailer bed;
the extension arms extend beyond the trailer bed perimeter while maintaining stability through support legs.

19. The dynamic multi axis multi-mounting platforms system of claim 1, wherein:
the at least one extension arm is configured for marine applications;
the system maintains structural integrity in submerged conditions.

20. The dynamic multi axis multi-mounting platforms system of claim 1, further comprising:
a photovoltaic eye connected to an electro-mechanical gimbal;
wherein the gimbal enables 360 degrees azimuth and 90 degrees elevation adjustment for solar tracking.

21. The dynamic multi axis multi-mounting platforms system of claim 1, wherein:
the at least one extension arm comprises a receiver hitch tube that extends through the mounting platform;
the mounting platform is slidably adjustable along the length of the receiver hitch tube.

22. The system of claim 5, further comprising:
hydraulic rams configured to replace the swing jacks for heavy load applications;
wherein the hydraulic rams provide enhanced lifting and leveling capabilities.

23. The dynamic multi axis multi-mounting platforms system of claim 1, wherein:
the at least one receiver hitch coupler includes a reducer coupler;
the reducer coupler enables connection between different sized receiver hitch components.

24. The assembly of claim 8, further comprising:
an anti-rattle device configured to prevent movement between interconnected components;
wherein the anti-rattle device is optional based on specific configuration requirements.

25. The dynamic multi axis multi-mounting platforms system of claim 1, wherein:
the at least one extension arm is configured for weapons mounting on naval vessels;
the system maintains secure attachment in marine environments.

26. The system of claim 5, wherein:
the interconnected mounting platforms are configured to support structural beams;
the system provides support underneath buildings through flat plate coupler attachment to I-beams.

27. The dynamic multi axis multi-mounting platforms system of claim 1, further comprising:
an expansion plate attachable to the mounting surface;
wherein the expansion plate increases the mounting surface area for larger base profiles.

28. The system of claim 5, wherein:
the interconnected mounting platforms are configured for commercial solar farm installations;
multiple platforms are interconnectable for extensive solar panel arrays.

29. The assembly of claim 8, wherein:
the spider-like configuration enables multi-directional expansion;
the outrigger tubes are independently adjustable while maintaining standardized connection requirements.
